(19) United States
(12) Patent Application Publication
(10) Pub. No.: US 2006/0219468 A1
(43) Pub. Date: Oct. 5, 2006

(54) Power steering apparatus

(76) Inventors: Shuji Shin, Tokyo (JP); Hiroki Hasegawa, Tokyo (JP); Takaaki Tsutsui, Tokyo (JP)

Correspondence Address: RABIN & Berdo, PC, 1101 14TH STREET, NW, SUITE 500, WASHINGTON, DC, 20005, US

(21) Appl. No.: 11/378,382

(22) Filed: Mar. 20, 2006

(30) Foreign Application Priority Data
Mar. 31, 2005 (JP) 2005-101163

(51) Int. Cl. B62D 5/06

(52) U.S. Cl. 180/428

(57) ABSTRACT

A rack-and-pinion mechanism (21) for changing a direction of wheels in accordance with a steering input, and a power cylinder (20) providing for power assist for operation of the rack-and-pinion mechanism (21) are provided. A rack shaft (9) of the rack-and-pinion mechanism (21) and a piston rod (3) of the power cylinder (20) are placed parallel to each other. The both ends of the rack shaft (9) and the both ends of the piston rod (3) are respectively linked through connecting members (6, 7). The piston rod (3) and the rack shaft (9) are separated from each other, thereby increasing the design flexibility of them.

### BACKGROUND OF THE INVENTION

1. Field of the Invention

This invention relates to a power steering apparatus, particularly suitable for use in a large vehicle.

2. Description of the Related Art

One of the conventional power steering apparatuses of the type described above is disclosed in JP-11-321682A. In the conventional apparatus, a piston rod of a power cylinder and a rack shaft of a rack-and-pinion mechanism are integrally formed and placed coaxially.

### SUMMARY OF THE INVENTION

Various problems arise when a conventional power steering apparatus structured as described above is mounted on a large vehicle.

One of the problems is an increase in size of the entire apparatus as the diameter of the rack shaft is increased. Since the rack is formed on the rack shaft, the rack shaft needs to have a large diameter in order to keep sufficient strength for the rack. In particular, in a large vehicle, due to the large steering resistance, a rack shaft of a significantly large diameter is required. However, because the rack shaft and the piston rod are combined as described above, as the diameter of the rack shaft is increased, the diameter of the piston rod must also be increased.

In this case, it is impossible to increase the diameter of just the piston rod without a change in the diameter of the piston. This is because if only the piston rod is relatively increased in diameter without changing the piston diameter, the pressure-receiving area of the piston is reduced, so that an intended output cannot be provided. Accordingly, an increase in the rack shaft diameter results in a need to increase the diameter of the power cylinder, leading to an increase in size of the entire apparatus.

In another problem, as the power cylinder is increased in size in order for it to produce an increased thrust, the rack shaft must be increased in diameter. This is because, for an increase of the thrust of the power cylinder, the diameter of the piston rod must be increased with regard to its strength and the like. An increase in the diameter of the piston rod results in an increase in the diameter of the rack shaft combined with the piston rod. A large vehicle particularly requires a considerably high thrust on the part of the power cylinder. If the power cylinder requires a piston rod of a larger diameter than that required for ensuring the strength of the rack shaft of the rack-and-pinion mechanism, the diameter of the rack shaft exceeds the limits of the specifications, resulting in a disadvantage in terms of costs.

That is to say, the power cylinder and the rack-and pinion mechanism must be identical in dimensional specifications at all times because the piston rod and the rack shaft are formed integrally as described earlier. Such a requirement of the same specifications for both of them gives rise to the impossibility of responding, for example, to a request for only increasing the thrust of the power cylinder without changing the size of the rack shaft in accordance with a vehicle type.

A further problem is produced by the difference between the piston rod and the rack shaft in the direction of the force acting. Specifically, the piston rod is acted upon by a thrust in the axial direction. On the other hand, the rack shaft is acted upon additionally by a component force in a direction at right angles to the axial direction because the rack is pressed against the pinion in order to engage the pinion with the rack without backlash. So, the component force also acts on the piston rod. However, when the piston rod is acted upon by the force at right angles to the axial direction, this causes the occurrence of unbalanced wear on the piston, piston rod, sealing member or the like, for example.

In view of the above, there exists a need for a power steering apparatus which overcomes the above-mentioned problems in the related art. The present invention addresses these needs in the related art, as well as other needs, which will become apparent to those skilled in the art from this disclosure.

It is an object of the present invention to provide a power steering apparatus equipped with a piston rod and a rack shaft which are separated from each other in order to solve the conventional problems as described above.

In order to achieve above the object an aspect of the present invention provides a power steering apparatus equipped with a rack-and-pinion mechanism for changing a direction of wheels in accordance with a steering input, and a power cylinder providing for power assist for operation of the rack-and-pinion mechanism. The power steering apparatus includes a rack shaft of the rack-and-pinion mechanism, a piston rod projecting from both ends of the power cylinder and placed in parallel to the rack shaft, and connecting members each link both ends of the rack shaft to both ends of the piston rod.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWING

FIG. 1 is a sectional view illustrating an embodiment of the present invention.

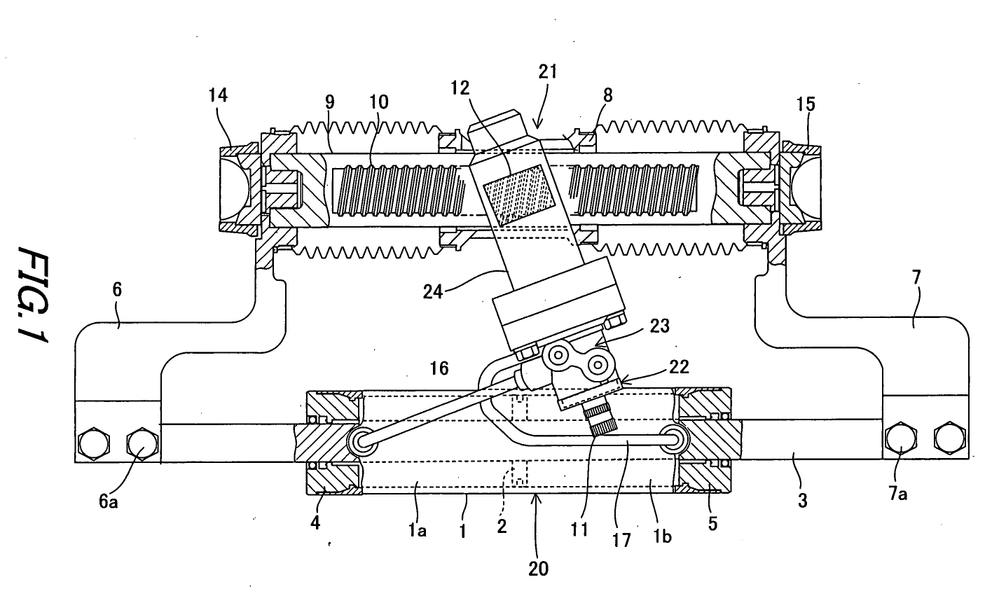

### DETAILED DESCRIPTION OF THE PREFERRED EMBODIMENT

A referred embodiment of the present invention will be explained with reference to the drawings. It will be apparent to those skilled in the art from this disclosure that the following description of the preferred embodiment of the present invention is provided for illustration only, and not for the purpose of limiting the present invention as defined by the appended claims and their equivalents.

The preferred embodiment illustrates a power steering apparatus used in a large vehicle.

A power cylinder 20 providing for power assist for the steering operation of the vehicle includes a cylinder tube 1, a piston 2 slidable in the cylinder tube 1 and a piston rod 3 secured to the piston 2.

The piston rod 3 extends outward through the both ends of the cylinder tube 1. The inside of the cylinder tube 1 is divided by the piston 2 into two cylinder chambers 1a and 1b. The piston rod 3 is movably supported by bearings 4 and 5 which are respectively provided at the both ends of the cylinder tube 1. The cylinder tube 1 is secured to the vehicle body (not shown).

As described later, by supplying pressure oil selectively into the cylinder chamber 1a, 1b, the piston 2 moves inside the cylinder tube 1 and thus the piston rod 3 moves in the axial direction.

The both ends of the piston rod 3 protruding from the cylinder tube 1 are linked through connecting members 6 and 7 to a rack-and-pinion mechanism 21. The ends of the respective connecting members 6 and 7 are detachably joined to the corresponding ends of the piston rod 3 with bolts 6a and 7a.

The rack-and-pinion mechanism 21 for changing the direction of the wheels in accordance with the steering operation includes a rack shaft 9. The rack shaft 9 extends through a support member 8 fixed to the vehicle body (not shown), so as to be supported thereon. The rack shaft 9 is supported parallel to the piston rod 3. The other ends of the respective connecting members 6 and 7 are connected to the both ends of the rack shaft 9. Accordingly, the piston rod 3 and the rack shaft 9 are combined with each other and move the same distance in the same direction.

The connection between the rack shaft 9 and the connecting members 6 and 7 is detachable.

The both ends of the rack shaft 9 are respectively connected to tie-rods 14 and 15 which are linked to the wheels (not shown) This structure enables a change in the direction of the wheels (not shown) when the rack shaft 9 moves in the axial direction.

A rack 10 is formed on a side face of the rack shaft 9 and extends in the axial direction. A pinion. 12 is engaged with the rack 10 and fixed to an input shaft 11.

The input shaft 11 is rotatably supported inside a housing 24 of the rack-and-pinion mechanism 21 and linked to the steering wheel (not shown). Thus, the input shaft 11 rotates with the operation of the steering wheel, whereupon the rotating force is applied to the pinion 12 to rotate it. The rotation is fed to the rack 10 which is engaged with the pinion 12, so that the rack shaft 9 moves in the axial direction.

The input shaft 11 is functionally connected to a steering torque detection mechanism 22 and a valve mechanism 23.

The torque detection mechanism 22 detects the steering torque acting on the input shaft 11. The valve mechanism 23 is switched in accordance with a rotational direction of the input shaft 11, and controls the supply flow rate of hydraulic fluid to the power cylinder 20 in accordance with the steering torque.

The valve mechanism 23 and the cylinder chambers 1a and 1b of the cylinder tube 1 communicate with each other by means of pipes 16 and 17. The hydraulic fluid is supplied and discharged through the pipes 16 and 17.

The hydraulic fluid is supplied from a hydraulic source (not shown) that is provided with a hydraulic pump usually driven by the engine of the vehicle and a reservoir holding the hydraulic fluid.

The piston rod 3 and the rack shaft 9 are placed in parallel to each other as described above. The axis of the input shaft 11 is placed parallel to the plane in which the axes of the piston rod 3 and rack shaft 9 are placed.

The input shaft 11 extends toward the cylinder tube 1,instead of this structure the input shaft 11 may extend to the opposite direction namely toward the rack 10.

Next, the operation in the embodiment will be described. Upon the operation of the steering wheel (not shown), the input shaft 11 rotates, and the rotating force is applied to the pinion 12 in accordance with the rotational direction of the input shaft 11. Upon the application of the rotating force to the pinion 12, the pinion 12 drives the rack shaft 9 in the rotational direction, and simultaneously the steering torque detection mechanism 22 detects the steering torque corresponding to the rotating force applied to the pinion 12. After the steering torque is detected by the steering torque detection mechanism 22, the valve mechanism 23 supplies hydraulic fluid to the power cylinder 20 in appropriate supply flow rate to the detected torque in accordance with the rotational direction of the input shaft 11.

More specifically, any one of the cylinder chambers 1a and 1b of the power cylinder 20 is fluidly connected to the oil pump and the other is fluidly connected to the tank. Thus, the piston 2 of the power cylinder 20 is moved by these oil pressures, so that the piston rod 3 moves in the axial direction.

As long as the piston rod 3 moves in the axial direction as described above, the rack shaft 9 linked to the piston rod 3 through the connecting members 6 and 7 also moves in the same axial direction. The direction of movement of the rack shaft 9 at this time point agrees with the rotational direction of the pinion 12 engaged with the rack 10. That is, the power-cylinder 20 provides power assist for the pinion 12 driving the rack shaft 9.

When the rack shaft 9 moves in the axial direction in synchronization with the rotation of the pinion 12 in this manner, the tie-rods 14 and 15 move, thereby changing the direction of the wheels (not shown).

According to the present invention, thus, since the piston rod 3 and the rack shaft 9 are detachable from each other by means of the connecting members 6 and 7, it is possible to establish the dimensional specifications of the piston rod 3 and the rack shaft 9 independently of each other, resulting in an increase in the flexibility of design.

For this reason, even when the rack-and-pinion mechanism 21 is not replaced, alternative power cylinder 20 of a different capacity can be combined with the rack-and-pinion mechanism 21 for use.

For example, this eliminates the need to use a rack shaft 9 of a large diameter even when the diameter of the piston rod 3 of the alternative power cylinder 20 is larger. Inconsequence, the use of a small-diameter rack shaft 9 makes a reduction in size of the entire power steering apparatus possible. Further, the same components can be used for various types, resulting in an advantage in terms of cost.

Because the four ends of the rack shaft 9 and piston rod 3 which are placed in parallel are correspondingly linked by the connecting members 6 and 7, the thrust of the piston rod 3 acts equally on the both ends of the rack shaft 9, and also a power-assist force caused by the power cylinder 20 is efficiently transferred to the rack shat 9 without action of a component force at an angle to the rack axis.

Further, the rack shaft 9 and the piston rod 3 are placed in parallel and the input shaft 11 provided with the pinion 12 is placed parallel to the plane in which the axes of the rack shaft 9 and the piston rod 3 are placed. Hence, even when the force transfer between the pinion 12 and the rack 10 causes a component force in a direction at right angles to the engagement face between the pinion 12 and the rack 10 to occur on the rack shaft 9, the component force will not act directly as a force bending the piston rod 3. For this reason, an action force from a direction at right angles to the axial direction of the piston rod 3 is not applied, thereby eliminating the disadvantage of unbalanced wear on the piston 2, the piston rod 3, a sealing member or the like of the power cylinder 20.

This application claims priority to Japanese Patent Application No. 2005-101163. The entire disclosure of Japanese Patent Application No. 2005-101163 is hereby incorporated herein by reference.

While only a selected preferred embodiment has been chosen to illustrate the present invention, it will be apparent to those skilled in the art from this disclosure that various changes and modifications can be made herein without departing from the scope of the invention as defined in the appended claims. Furthermore, the foregoing description of the preferred embodiment according to the present invention is provided for illustration only, and not for the purpose of limiting the invention as defined by the appended claims and their equivalents.

What is claimed is:

1. A power steering apparatus equipped with a rack-and-pinion mechanism for changing a direction of wheels in accordance with a steering input, and a power cylinder providing for power assist for operation of the rack-and-pinion mechanism, comprising:
a rack shaft of the rack-and-pinion mechanism;
a piston rod projecting from both ends of the power cylinder and placed in parallel to the rack shaft; and
connecting members each link both ends of the rack shaft to both ends of the piston rod.

2. A power steering apparatus according to claim 1, wherein:
each of the connecting members is detachably connected to the piston rod and the rack shaft.

3. A power steering apparatus according to claim 1, wherein:
a pinion provided on an input shaft of the rack-and-pinion mechanism is engaged with a rack provided on the rack shaft; and
the input shaft is provided in a position to place an axis of the input -shaft in parallel to a plane in which axes of the piston rod and the rack shaft are placed.
